(19) United States
(12) Patent Application Publication
(10) Pub. No.: US 2024/0088432 A1
(43) Pub. Date: Mar. 14, 2024

(54) Sulfur Dioxide-Based Inorganic Electrolyte Doped with Fluorine Compound, Method of Manufacturing the Same, and Secondary Battery Including the Same

(71) Applicants: Hyundai Motor Company, Seoul (KR); Kia Corporation, Seoul (KR); IUCF-HYU (Industry-University Cooperation Foundation Hanyang University), Seoul (KR)

(72) Inventors: Kyu Ju Kwak, Hwaseong-si (KR); Won Keun Kim, Seoul (KR); Eun Ji Kwon, Yongin-si (KR); Samuel Seo, Yongin-si (KR); Yeon Jong Oh, Seoul (KR); Kyoung Han Ryu, Yongin-si (KR); Dong Hyun Lee, Seoul (KR); Han Su Kim, Seoul (KR); Ji Whan Lee, Seoul (KR); Seong Hoon Choi, Seoul (KR); Seung Do Mun, Seoul (KR)

(21) Appl. No.: 18/299,298

(22) Filed: Apr. 12, 2023

(30) Foreign Application Priority Data
Sep. 14, 2022 (KR) 10-2022-0115763

(51) Int. Cl. H01M 10/0562; H01M 4/38; H01M 50/46

(52) U.S. Cl. CPC H01M 10/0562; H01M 4/382; H01M 50/46; H01M 2004/027

(57) ABSTRACT

An embodiment sulfur dioxide-based inorganic electrolyte is provided in which the sulfur dioxide-based inorganic electrolyte is represented by a chemical formula M·(A1·Cl₍₄₋ₓ₎Fₓ)_{z}·ySO₂. In this formula, M is a first element selected from the group consisting of Li, Na, K, Ca, and Mg, A1 is a second element selected from the group consisting of Al, Fe, Ga, and Cu, x satisfies a first equation 0≤x≤4, y satisfies a second equation 0≤y≤6, and z satisfies a third equation 1≤z≤2.

### CROSS-REFERENCE TO RELATED APPLICATIONS

This application claims the benefit of Korean Patent Application No. 10-2022-0115763, filed on Sep. 14, 2022, which application is hereby incorporated herein by reference.

### TECHNICAL FIELD

The present disclosure relates to a sulfur dioxide-based inorganic electrolyte doped with a fluorine compound, a method of manufacturing the same, and a secondary battery including the same.

### BACKGROUND

Secondary batteries which are rechargeable are widely used in small electronic devices, such as a cellular phone and a notebook computer, and in large vehicles, such as a hybrid vehicle and an electric vehicle. Accordingly, the need for high-capacity secondary batteries is increasing. Lithium metal has a high theoretical capacity and a very low oxidation-reduction potential and is spotlighted as an anode material for high-capacity and high-energy density lithium secondary batteries.

An organic electrolyte including a lithium salt and an organic solvent is generally used as an electrolyte for lithium secondary batteries, but such an organic electrolyte is highly combustible and thus use of the organic electrolyte may cause a serious problem in safety when a secondary battery is driven.

Therefore, in order to solve this problem, use of an inorganic (liquid) electrolyte has been proposed.

However, when the inorganic electrolyte is applied to a lithium ion battery, the inorganic electrolyte has excellent ionic conductivity and flame retardancy but has excellent reactivity to lithium metal during charging and discharging of the lithium ion battery, and thus the capacity and lifespan of the lithium ion battery are reduced due to precipitates generated on the surface of the lithium metal at an anode of the lithium ion battery.

The above information disclosed in this background section is only for enhancement of understanding of the background of embodiments of the disclosure and therefore it may contain information that does not form the prior art that is already known to a person of ordinary skill in the art.

### SUMMARY

Embodiments of the present disclosure can solve problems associated with the prior art, and an embodiment of the present disclosure provides a sulfur dioxide-based inorganic electrolyte doped with a fluorine compound which controls the composition of a film layer formed on the surface of a metal at an anode during charging and discharging of a secondary battery so as to improve reliability and safety, and a method of manufacturing the same.

Another embodiment of the present disclosure provides a secondary battery which includes the above sulfur dioxide-based inorganic electrolyte so as to have an improved lifespan.

One embodiment of the present disclosure provides a sulfur dioxide-based inorganic electrolyte represented by Chemical Formula 1:

M·(A1·Cl₍₄₋ₓ₎Fₓ)_{z}·ySO₂, Chemical Formula 1

wherein M is one selected from the group consisting of Li, Na, K, Ca, and Mg, A1 is one selected from Al, Fe, Ga, and Cu, x satisfies an equation 0≤x≤4, y satisfies an equation 0≤y≤6, and z satisfies an equation 1≤z≤2.

In a preferred embodiment, a molar content of fluorine (F) in the sulfur dioxide-based inorganic electrolyte may be 0.03 to 0.9.

In another preferred embodiment, a molar content of fluorine (F) in the sulfur dioxide-based inorganic electrolyte may be 0.04 to 1.2.

Another embodiment of the present disclosure provides a secondary battery including a cathode, an anode comprising lithium metal, a film layer located on a surface of the lithium metal and including a fluorine compound, and a separator located between the cathode and the anode, wherein the secondary battery is impregnated with the above inorganic electrolyte.

In a preferred embodiment, the fluorine compound may include aluminum fluoride (AlF₃).

In another preferred embodiment, the film layer may have a thickness of 3 to 150 μm.

Yet another embodiment of the present disclosure provides a method of manufacturing a sulfur dioxide-based inorganic electrolyte, the method including preparing a mixture by mixing metal chlorides and at least one fluorine compound, and synthesizing the inorganic electrolyte doped with the at least one fluorine compound by injecting sulfur dioxide (SO₂) gas into the mixture, wherein the sulfur dioxide-based inorganic electrolyte is represented by Chemical Formula 1:

M·(A1·Cl₍₄₋ₓ₎Fₓ)_{z}·ySO₂, Chemical Formula 1

wherein M is one selected from the group consisting of Li, Na, K, Ca, and Mg, A1 is one selected from Al, Fe, Ga, and Cu, x satisfies an equation 0≤x≤4, y satisfies an equation 0≤y≤6, and z satisfies an equation 1≤z≤2.

In a preferred embodiment, the metal chlorides may include a first metal chloride including one selected from the group consisting of aluminum chloride (AlCl₃), iron chloride (FeCl₃), and gallium chloride (GaCl₃), and a second metal chloride including one selected from the group consisting of lithium chloride (LiCl), sodium chloride (NaCl), potassium chloride (KCl), calcium chloride (CaCl₂), and magnesium chloride (MgCl₂), and the at least one fluorine compound may include a first fluorine compound including one selected from the group consisting of aluminum fluoride (AlF₃), iron fluoride (FeF₃), gallium fluoride (GaF₃), and combinations thereof.

In another preferred embodiment, a molar content of fluorine (F) in the sulfur dioxide-based inorganic electrolyte may be 0.03 to 0.9.

In still another preferred embodiment, in preparing the mixture, a content of the first fluorine compound may be equal to or less than 11 mol % to a content of the first metal chloride.

In yet another preferred embodiment, a mixing molar ratio of the first fluorine compound to the first metal chloride may be 1:3 to 1:100.

In still yet another preferred embodiment, a mixing molar ratio of the first fluorine compound to the first metal chloride may be 1:8 to 1:10.

In a further preferred embodiment, two or more fluorine compounds may be used.

In another further preferred embodiment, the metal chlorides may include a first metal chloride including one selected from the group consisting of aluminum chloride (AlCl₃), iron chloride (FeCl₃), and gallium chloride (GaCl₃), and a second metal chloride including one selected from the group consisting of lithium chloride (LiCl), sodium chloride (NaCl), potassium chloride (KCl), calcium chloride (CaCl₂), and magnesium chloride (MgCl₂), and the at least one fluorine compound may include a first fluorine compound including one selected from the group consisting of aluminum fluoride (AlF₃), iron fluoride (FeF₃), and gallium fluoride (GaF₃), and a second fluorine compound including one selected from the group consisting of lithium fluoride (LiF), sodium fluoride (NaF), potassium fluoride (KF), calcium fluoride (CaF₂), and magnesium fluoride (MgF₂).

In still another further preferred embodiment, a molar content of fluorine (F) in the sulfur dioxide-based inorganic electrolyte may be 0.04 to 1.2.

In yet another further preferred embodiment, in preparing the mixture, a content of the first fluorine compound may be equal to or less than 11 mol % to a content of the first metal chloride, and a content of the second fluorine compound may be equal to or less than 11 mol % to a content of the second metal chloride.

In still yet another further preferred embodiment, a mixing molar ratio of the first fluorine compound to the first metal chloride may be 1:3 to 1:100, and a mixing molar ratio of the second fluorine compound to the second metal chloride may be 1:3 to 1:100.

In a still further preferred embodiment, a mixing molar ratio of the first fluorine compound to the first metal chloride may be 1:8 to 1:10, and a mixing molar ratio of the second fluorine compound to the second metal chloride may be 1:8 to 1:10.

Other aspects and preferred embodiments of the disclosure are discussed infra.

The above and other features of embodiments of the disclosure are discussed infra.

### BRIEF DESCRIPTION OF THE DRAWINGS

The above and other features of embodiments of the present disclosure will now be described in detail with reference to certain exemplary embodiments thereof illustrated in the accompanying drawings which are given hereinbelow by way of illustration only, and thus are not limitative of the present invention, and wherein:

FIG. 1 is a longitudinal-sectional view showing a secondary battery according to embodiments of the present invention;

FIG. 2A is a flowchart representing a method of manufacturing a sulfur dioxide-based inorganic electrolyte according to embodiments of the present invention;

FIG. 2B is a view schematically illustrating a method according to embodiments of the present invention;

FIG. 3 shows graphs representing results of electrochemical evaluation of secondary batteries according to Examples and Comparative Examples;

FIGS. 4A and 4B are graphs representing results of Raman spectroscopy of electrolytes according to Examples and Comparative Examples;

FIG. 5 is a graph representing results of Raman spectroscopy of AlF₃—;

FIGS. 6A and 6B are scanning electron microscope (SEM) images of the cross-section of lithium metal in the battery to which the electrolyte according to Comparative Example 1 is applied;

FIGS. 7A and 7B are SEM images of the cross-section of lithium metal in the battery to which the electrolyte according to Comparative Example 2 is applied;

FIGS. 8A and 8B are SEM images of the cross-section of lithium metal in the battery to which the electrolyte according to Example 1 is applied;

FIG. 9 is an image of an energy dispersive spectroscopy (EDS) mapping area of the cross-section of the lithium metal in the battery to which the electrolyte according to Example 1 is applied;

FIGS. 10A to 10F are images showing results of EDS mapping of the cross-section of the lithium metal in the battery to which the electrolyte according to Example 1 is applied;

FIGS. 11A and 11B are SEM images of the cross-section of lithium metal in the battery to which the electrolyte according to Example 2 is applied;

FIG. 12 is an image of an EDS mapping area of the cross-section of the lithium metal in the battery to which the electrolyte according to Example 2 is applied;

FIGS. 13A to 13F are images showing results of EDS mapping of the cross-section of the lithium metal in the battery to which the electrolyte according to Example 2 is applied;

FIGS. 14A to 14E are graphs representing results of x-ray photoelectron spectroscopy (XPS) of the lithium metal, after the formation process of the battery using the electrolyte according to Comparative Example 1;

FIGS. 15A to 15E are graphs representing results of XPS of the lithium metal, after 100 cycles of the battery using the electrolyte according to Comparative Example 1;

FIGS. 16A to 16F are graphs representing results of XPS of the lithium metal, after the formation process of the battery using the electrolyte according to Comparative Example 2;

FIGS. 17A to 17F are graphs representing results of XPS of the lithium metal, after 100 cycles of the battery using the electrolyte according to Comparative Example 2;

FIGS. 18A to 18F are graphs representing results of XPS of the lithium metal, after the formation process of the battery using the electrolyte according to Example 1;

FIGS. 19A to 19F are graphs representing results of XPS of the lithium metal, after 100 cycles of the battery using the electrolyte according to Example 1;

FIG. 20 is a graph representing results of measurement of capacities, after application of the inorganic electrolytes according to Examples and Comparative Examples to LFP cathodes and lithium metal cathodes; and

FIG. 21 is a graph representing results of a charge and discharge cycle test, after application of the inorganic electrolytes according to Examples and Comparative Examples to the LFP cathodes and the lithium metal cathodes.

It should be understood that the appended drawings are not necessarily to scale, presenting a somewhat simplified representation of various preferred features illustrative of the basic principles of embodiments of the invention. The specific design features of embodiments of the present disclosure as disclosed herein, including, for example, specific dimensions, orientations, locations, and shapes, will be determined in part by the particular intended application and use environment.

In the figures, reference numbers refer to the same or equivalent parts of embodiments of the present disclosure throughout the several figures of the drawings.

### DETAILED DESCRIPTION OF ILLUSTRATIVE EMBODIMENTS

The above-described objects, other objects, advantages, and features of embodiments of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising”, and “having”, are to be interpreted as indicating the presence of characteristics, numbers, steps, operations, elements, or parts stated in the description or combinations thereof, and do not exclude the presence of one or more other characteristics, numbers, steps, operations, elements, parts, or combinations thereof, or possibility of adding the same. In addition, it will be understood that when a part, such as a layer, a film, a region, or a plate, is said to be “on” another part, the part may be located “directly on” the other part or other parts may be interposed between the two parts. In the same manner, it will be understood that when a part, such as a layer, a film, a region, or a plate, is said to be “under” another part, the part may be located “directly under” the other part or other parts may be interposed between the two parts.

All numbers, values and/or expressions representing amounts of components, reaction conditions, polymer compositions, and blends used in the description are approximations in which various uncertainties in measurement generated when these values are acquired from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

Prior to description of embodiments of the present invention, secondary batteries according to embodiments of the present disclosure will be described as lithium secondary batteries, but are not limited thereto.

Respective elements of a secondary battery according to embodiments of the present disclosure will be described below in detail.

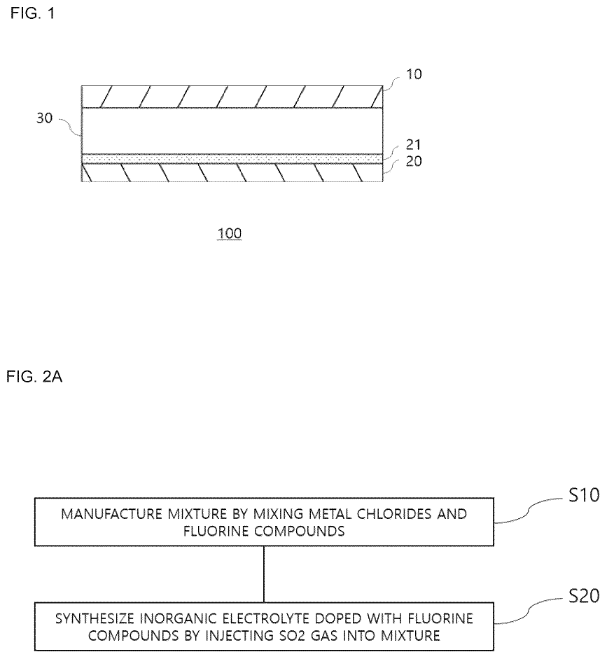

FIG. 1 is a longitudinal-sectional view showing a secondary battery according to embodiments of the present invention. Referring to FIG. 1, a secondary battery 100 may include a cathode 10, an anode 20, a film layer 21, and a separator 30 located between the cathode 10 and the anode 20. The secondary battery may be impregnated with an electrolyte (not shown).

The cathode 10 may include a cathode active material, a binder, a conductive material, etc.

Concretely, the cathode active material may include at least one selected from the group consisting of lithium cobalt oxide, lithium nickel cobalt manganese oxides, lithium nickel cobalt aluminum oxides, lithium iron phosphate, lithium manganese oxide, and combinations thereof. However, the cathode active material is not limited thereto, and may employ any cathode active material, which is usable in the art to which embodiments of the present disclosure pertain.

The binder is a material which assists binding between the cathode active material and the conductive material and binding with a current collector, and may include at least one selected from the group consisting of poly(vinylidene fluoride), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene propylene diene terpolymer (EPDM), sulfonated EPDM, styrene butadiene rubber (SBR), fluorine rubber, and various copolymers.

The conductive material may include any material which is conductive while not causing chemical change of the corresponding battery, without being limited thereto, and, for example, may include at least one selected from the group consisting of graphite, such as natural graphite or artificial graphite, a carbon-based material, such as carbon black, acetylene black, Ketjen black, channel black, furnace black, lamp black, or summer black, conductive fiber, such as carbon fiber or metal fiber, metal powder, such as fluorinated carbon, aluminum, or nickel powder, a conductive metal oxide, such as titanium oxide, and a conductive material, such as a polyphenylene derivative.

The anode 20 may include lithium metal or a lithium metal alloy.

The lithium metal alloy may include an alloy of lithium and a metal or a metalloid which is alloyable with lithium. The metal or the metalloid which is alloyable with lithium may include Si, Sn, Al, Ge, Pb, Bi or Sb. The lithium metal has a high capacitance per unit weight and is advantageous in implementation of a high capacity battery.

The film layer 21 may be located on the surface of the lithium metal, may include at least one fluorine compound, and may have a thickness of 3 to 150 μm.

The at least one fluorine compound in the film layer 21 is derived from an inorganic electrolyte which will be described below, and concretely, may include aluminum fluoride (AlF₃).

The film layer 21 may be formed on the surface of the lithium metal after a formation process and may be referred to as a solid electrolyte interface (SEI) film.

The SEI film is formed at the initial stage of charging of the secondary battery, prevents reaction between lithium ions and a lithium anode or other materials during a process of charging and discharging the secondary battery, and serves as an ion tunnel and thus passes only lithium ions. Therefore, the SEI film passes only lithium ions and thus prevents direct contact between the electrolyte and the lithium anode having high reactivity.

Therefore, the SEI film serves as a kind of passivation layer, side reaction between lithium ions and the lithium anode or other materials is prevented, and the amount of the lithium ions is reversibly maintained. Further, a lithium secondary battery does not show irreversible passivation layer formation reaction any more after initial charging of the lithium secondary battery and maintains a stable cycle life.

When the SEI film is non-uniformly formed, supply of lithium ions becomes unstable, and thus, lithium dendrites are grown on the surface of the lithium metal. Further, non-uniform deposition of lithium ions continuously causes side reaction between the lithium metal and the electrolyte, thus increasing the thickness of an interface layer with the solid electrolyte and causing exhaustion of the electrolyte.

In embodiments of the present invention, a stable SEI film is formed on the surface of the lithium metal by doping the inorganic electrolyte with fluorine (F) ions, thereby being capable of reducing overvoltage generated during charging and discharging of the lithium secondary battery and thus improving reliability and safety of the secondary battery.

Therefore, in embodiments of the present invention, the film layer including aluminum fluoride (AlF₃) formed on the surface of the lithium metal suppresses formation of dendrites on the surface of the lithium metal, and thereby, a lithium secondary battery having improved capacity characteristics may be manufactured.

The separator 30 serves to prevent contact between the cathode 10 and the anode 20. The separator 30 may include any material which is generally used in the art to which embodiments of the present disclosure pertain, without being limited thereto, and, for example, may include a polyolefin-based material, such as a glass fiber filter (GFF), polypropylene (PP), or polyethylene (PE).

In addition, embodiments of the present disclosure relate to an inorganic electrolyte for secondary batteries, and a sulfur dioxide-based inorganic electrolyte according to embodiments of the present disclosure is acquired through reaction between a mixture including metal chlorides and at least one fluorine compound and sulfur dioxide (SO₂) gas.

Concretely, respective components of the inorganic electrolyte according to an embodiment of the present disclosure will be described in more detail below.

The inorganic electrolyte may be represented by Chemical Formula 1 below.

M·(A1·Cl₍₄₋ₓ₎Fₓ)_{z}·ySO₂, Chemical Formula 1

In Chemical Formula 1, M is one selected from the group consisting of Li, Na, K, Ca, and Mg, A1 is one selected from Al, Fe, Ga, and Cu, x satisfies an equation 0≤x≤4, y satisfies an equation 0≤y≤6, and z satisfies an equation 1≤z≤2.

Concretely, the inorganic electrolyte may be represented by Chemical Formula 2 below.

LiAlCl₍₄₋ₓ₎Fₓ·ySO₂ Chemical Formula 2

In Chemical Formula 2, x satisfies an equation 0≤x≤4, and y satisfies an equation 0≤y≤6.

The inorganic electrolyte is a resulting product through the reaction occurring by injecting the sulfur dioxide (SO₂) gas into the mixture including the metal chlorides and the fluorine compounds.

The metal chlorides may include a first metal chloride including one selected from the group consisting of aluminum chloride (AlCl₃), iron chloride (FeCl₃), and gallium chloride (GaCl₃), and a second metal chloride including one selected from the group consisting of lithium chloride (LiCl), sodium chloride (NaCl), potassium chloride (KCl), calcium chloride (CaCl₂), and magnesium chloride (MgCl₂).

The at least one fluorine compound may include a first fluorine compound including one selected from the group consisting of aluminum fluoride (AlF₃), iron fluoride (FeF₃), gallium fluoride (GaF₃), and combinations thereof.

The mixing molar ratio of the first fluorine compound to the first metal chloride may be 1:3 to 1:100, and more particularly, may be 1:8 to 1:10. Here, it may be confirmed that the molar content of fluorine (F) in the inorganic electrolyte is 0.03 to 0.9.

Further, an inorganic electrolyte according to another embodiment of the present disclosure may include at least two fluorine compounds.

Concretely, the fluorine compounds may include a first fluorine compound including one selected from the group consisting of aluminum fluoride (AlF₃), iron fluoride (FeF₃), and gallium fluoride (GaF₃), and a second fluorine compound including one selected from the group consisting of lithium fluoride (LiF), sodium fluoride (NaF), potassium fluoride (KF), calcium fluoride (CaF₂), and magnesium fluoride (MgF₂).

The mixing molar ratio of the first fluorine compound to the first metal chloride may be 1:3 to 1:100, and more particularly, may be 1:8 to 1:10, and the mixing molar ratio of the second fluorine compound to the second metal chloride may be 1:3 to 1:100, and more particularly, may be 1:8 to 1:10. Here, it may be confirmed that the molar content of fluorine (F) in the inorganic electrolyte is 0.04 to 1.2.

Embodiments of the present disclosure relate to a secondary battery impregnated with the inorganic electrolyte, and the sulfur dioxide-based inorganic electrolyte doped with at least one fluorine compound has non-flammable properties and high ionic conductivity, and may thus be applied to the secondary battery so as to exhibit high electrochemical stability.

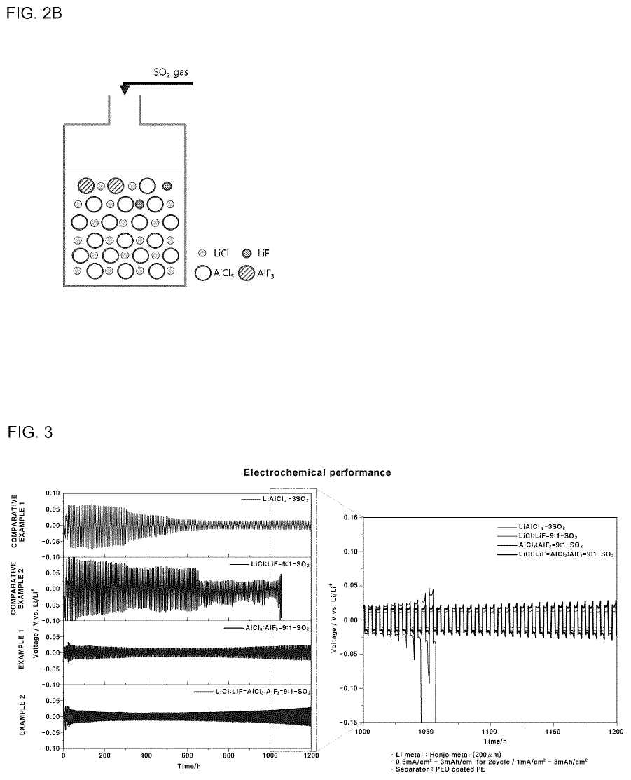

Further, embodiments of the present disclosure relate to a method of manufacturing a sulfur dioxide-based inorganic electrolyte. FIG. 2A is a flowchart representing a method according to embodiments of the present invention. FIG. 2B is a view schematically illustrating a method according to embodiments of the present invention.

Referring to FIGS. 2A and 2B, a method according to embodiments of the present disclosure includes manufacturing a mixture by mixing metal chlorides and at least one fluorine compound (S10), and synthetizing the inorganic electrolyte doped with the least one fluorine compound by injecting sulfur dioxide (SO₂) gas into the mixture (S20).

Here, the sulfur dioxide-based inorganic electrolyte is represented by Chemical Formula 1 below.

M·(A1·Cl₍₄₋ₓ₎Fₓ)_{z}·ySO₂ Chemical Formula 1

In Chemical Formula 1, M is one selected from the group consisting of Li, Na, K, Ca, and Mg, A1 is one selected from Al, Fe, Ga, and Cu, x satisfies an equation 0≤x≤4, y satisfies an equation 0≤y≤6, and z satisfies an equation 1≤z≤2.

Here, the metal chlorides may include a first metal chloride including one selected from the group consisting of aluminum chloride (AlCl₃), iron chloride (FeCl₃), and gallium chloride (GaCl₃), and a second metal chloride including one selected from the group consisting of lithium chloride (LiCl), sodium chloride (NaCl), potassium chloride (KCl), calcium chloride (CaCl₂), and magnesium chloride (MgCl₂).

First, in S10, a solid salt is manufactured by mixing the metal chlorides and the fluorine compounds in a powder form.

According to one embodiment of the present invention, the at least one fluorine compound may include a first fluorine compound including one selected from the group consisting of aluminum fluoride (AlF₃), iron fluoride (FeF₃), and gallium fluoride (GaF₃). Here, the content of the first fluorine compound which is mixed may be equal to or less than 11 mol % to the content of the first metal chloride.

Here, the mixing molar ratio of the first fluorine compound to the first metal chloride may be 1:3 to 1:100, and more particularly, the mixing molar ratio of the first fluorine compound to the first metal chloride may be 1:8 to 1:10.

Further, according to another embodiment of the present invention, at least two fluorine compounds may be used.

According to another embodiment of the present invention, in S10, in addition to the first fluorine compound, a second fluorine compound including one selected from the group consisting of lithium fluoride (LiF), sodium fluoride (NaF), potassium fluoride (KF), calcium fluoride (CaF₂), and magnesium fluoride (MgF₂) may be added.

Here, the content of the first fluorine compound which is mixed may be equal to or less than 11 mol % to the content of the first metal chloride, and the content of the second fluorine compound which is mixed may be equal to or less than 11 mol % to the content of the second metal chloride.

Here, the mixing molar ratio of the first fluorine compound to the first metal chloride may be 1:3 to 1:100, and the mixing molar ratio of the second fluorine compound to the second metal chloride may be 1:3 to 1:100. More particularly, the mixing molar ratio of the first fluorine compound to the first metal chloride may be 1:8 to 1:10, and the mixing molar ratio of the second fluorine compound to the second metal chloride may be 1:8 to 1:10.

Thereafter, in S20, sulfur dioxide (SO₂) gas is injected into the mixture in the form of the solid salt. In S20, the inorganic electrolyte in a liquid state is manufactured by injecting sulfur dioxide (SO₂) gas into the solid salt. Here, in S20, the inorganic electrolyte doped with the at least one fluorine compound may be acquired.

Hereinafter, embodiments of the present disclosure will be described in more detail through the following examples. The following examples serve merely to exemplarily describe embodiments of the present disclosure and are not intended to limit the scope of the invention.

### Test Example 1: Substitution with Fluorine in Metal Chloride

First, in order to confirm whether or not fluorine is applicable to conventional metal chlorides, inorganic electrolytes in a liquid state were synthetized by injecting sulfur dioxide (SO₂) gas into mixtures including metal chlorides (LiCl, NaCl, etc.) and fluorine compounds (LiF, AlF₃, etc.) having compositions in molar ratios set forth in Table 1 below.

Table 1 represents whether or not inorganic electrolytes are capable of being synthetized from the mixtures, and characteristics of the synthetized electrolytes.

TABLE 1

| Candidate | Mixing molar ratio | Synthesis |
|---|---|---|
| LiCl:LiF:AlCl₃ | 0.9:0.1:1 | possible |
| LiCl:AlCl₃:AlF₃ | 1:0.9:0.1 | possible |
| LiCl:LiF:AlCl₃:AlF₃ | 9:1:9:1 | possible |
| NaCl:NaF:AlCl₃ | 0.9:0.1:1 | possible |
| NaCl:AlCl₃:AlF₃ | 1:0.9:0.1 | possible |
| NaCl:NaF:AlCl₃:AlF₃ | 9:1:9:1 | possible |

Referring to Table 1 above, it may be confirmed that fluorine (F) has a higher oxidation potential than chlorine (Cl₂), and thus, chlorine (Cl₂) in chloroaluminate (AlCl₄⁻) was substituted with fluorine (F) and thereby a liquid inorganic electrolyte was synthetized.

### Test Example 2: Molar Ratio for Synthetizing Electrolyte

Thereafter, in order to check characteristics of inorganic electrolytes depending on the mixing molar ratios of chlorine (Cl₂) to fluorine (F) when the inorganic electrolytes are synthesized, inorganic electrolytes according to Examples and Comparative Examples were manufactured depending on mixing molar ratios of components set forth in Table 2 below.

TABLE 2

| Component | LiCl | LiF | AlCl₃ | AlF₃ |
|---|---|---|---|---|
| Comp. Example 1 | 1 | 0 | 1 | 0 |
| Comp. Example 2 | 0.9 | 0.1 | 1 | 0 |
| Example 1 | 1 | 0 | 0.9 | 0.1 |
| Example 2 | 0.9 | 0.1 | 0.9 | 0.1 |

### Example 1

A sulfur dioxide (SO₂)-based inorganic electrolyte doped with a fluorine (F) compound was synthesized by physically mixing lithium chloride (LiCl) powder, aluminum chloride (AlCl₃) powder, and aluminum fluoride (AlF₃) powder and then injecting sulfur dioxide (SO₂) gas into an acquired mixture.

Here, 11 mol % of aluminum fluoride (AlF₃) to the content of aluminum chloride (AlCl₃) was mixed, and the electrolyte represented by Chemical Formula 3 was manufactured.

LiAlCl₍₄₋ₓ₎Fₓ⁻·ySO₂ Chemical Formula 3

Here, x is 0.3, and y is a number within the range of 0 to 6.

### Example 2

A sulfur dioxide (SO₂)-based inorganic electrolyte doped with fluorine (F) compounds was synthesized by physically mixing lithium chloride (LiCl) powder, aluminum chloride (AlCl₃) powder, lithium fluoride (LiF) powder, and aluminum fluoride (AlF₃) powder and then injecting sulfur dioxide (SO₂) gas into an acquired mixture.

Concretely, 11 mol % of lithium fluoride (LiF) to the content of lithium chloride (LiCl) was mixed, 11 mol % of aluminum fluoride (AlF₃) to the content of aluminum chloride (AlCl₃) was mixed, and the electrolyte represented by Chemical Formula 4 was manufactured.

LiAlCl₍₄₋ₓ₎Fₓ⁻·ySO₂ Chemical Formula 4

Here, x is 0.4, and y is a number within the range of 0 to 6.

### Comparative Example 1

An electrolyte represented by Chemical Formula 5 was manufactured using the same method as in Example 1 except for aluminum fluoride (AlF₃) powder.

LiAlCl₄⁻·3SO₂ Chemical Formula 5

### Comparative Example 2

An electrolyte represented by Chemical Formula 6 was manufactured using the same method as in Example 1 except that aluminum fluoride (AlF₃) powder is replaced with lithium fluoride (LiF) powder.

Concretely, 11 mol % of lithium fluoride (LiF) to the content of lithium chloride (LiCl) was mixed, and the electrolyte represented by Chemical Formula 6 was manufactured.

LiAlCl₍₄₋ₓ₎Fₓ⁻·ySO₂ Chemical Formula 6

Here, x is 0.1, and y is a number within the range of 0 to 6.

Thereafter, in order to evaluate the performances of the electrolytes manufactured according to Examples and Comparative Examples, electrochemical evaluation of batteries to which the electrolytes are applied was conducted. Here, the manufactured batteries were coin-type CR 2032 batteries using lithium metal foil of 200 μm, and glass fiber filters (GFFs) were used as separators.

Here, in the electrochemical evaluation, current densities and capacities per area of the respective batteries were measured at 1 mA cm⁻² to 3 mAh cm⁻², and are shown in FIG. 3.

Referring to FIG. 3, the secondary battery according to Comparative Example 1 in which no fluorine compound was used and the mixing molar ratio of lithium chloride (LiCl) to aluminum chloride (AlCl₃) was 1:1 exhibited instability due to overvoltage generated at the beginning of the electrochemical evaluation.

In the same manner, the secondary battery according to Comparative Example 2 in which lithium fluoride (LiF) alone was used as a fluorine compound and the mixing molar ratio of lithium fluoride (LiF) to lithium chloride (LiCl) was 1:9 exhibited instability due to overvoltage generated at the beginning of the electrochemical evaluation and had poor capacity.

On the other hand, it was confirmed that, in the secondary battery according to Example 1 in which aluminum fluoride (AlF₃) was used as a fluorine compound and the mixing molar ratio of lithium chloride (LiCl) to aluminum chloride (AlCl₃) to aluminum fluoride (AlF₃) was 10:9:1, overvoltage was reduced after the formation process.

Here, the formation process indicates a process of activating a secondary battery so as to electrify the secondary battery, after assembly of the secondary battery. Concretely, in the formation process, the secondary battery sequentially undergoes a formation step, an aging step, and an IR/OCV testing step, and the secondary battery is activated and fault cells are selected through charging/discharging and aging of the secondary battery.

The secondary battery in a discharged state is charged so as to be activated in the formation step, and the secondary battery is stored at a predetermined temperature or humidity for a designated time so that an electrolyte in the secondary battery is sufficiently dispersed so as to optimize ion mobility in the aging step.

In the same manner, it was confirmed that, in the secondary battery according to Example 2 in which aluminum fluoride (AlF₃) was used as a fluorine compound and the mixing molar ratio of lithium chloride (LiCl) to lithium fluoride (LiF) to aluminum chloride (AlCl₃) to aluminum fluoride (AlF₃) was 9:1:9:1, overvoltage was reduced after the formation process.

Therefore, it may be confirmed that an electrolyte manufactured in which aluminum fluoride (AlF₃) is used as a fluorine compound so as to dope the electrolyte with fluorine (F) and the mixing molar ratio of aluminum chloride (AlCl₃) to aluminum fluoride (AlF₃) is 9:1 exhibits shortening of a time taken to secure stability and reduction in overvoltage in a lithium symmetric cell.

### Test Example 0.3: Component Analysis of Electrolytes

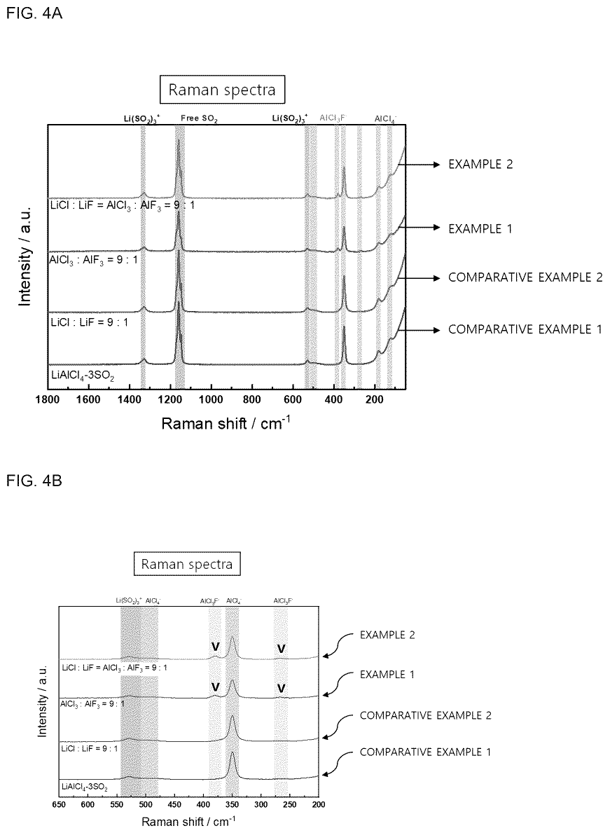

Thereafter, in order to confirm components of the electrolytes manufactured according to Examples and Comparative Examples, the components of the electrolytes according to Examples and Comparative Examples were analyzed using Raman spectroscopy. FIGS. 4A and 4B are graphs representing results of Raman spectroscopy of the electrolytes according to Examples and Comparative Examples.

Referring to FIG. 4A, it is confirmed that the electrolytes according to Examples 1 and 2 showed a new AlCl₃F⁻ band in a Raman spectral range of 380 cm⁻¹. On the other hand, it is confirmed that the electrolytes according to Comparative Examples 1 and 2 did not show a AlCl₃F⁻ band in the Raman spectral range of 380 cm⁻¹.

Further, referring to FIG. 4B, it is confirmed that the electrolytes according to Examples 1 and 2 showed an AlCl₃F⁻ band in a Raman spectral range of 260 cm⁻¹ as well as the Raman spectral range of 380 cm⁻¹. On the other hand, it is confirmed that the electrolytes according to Comparative Examples 1 and 2 did not show a AlCl₃F⁻ band in the Raman spectral ranges of 380 cm⁻¹ and 260 cm⁻¹.

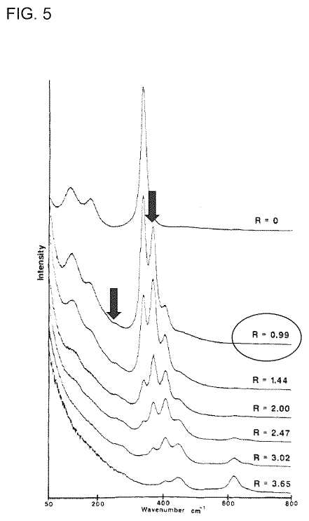

FIG. 5 is a graph representing results of Raman spectroscopy of AlCl₃F⁻. Referring to FIG. 5, it may be confirmed that AlCl₃F⁻ showed an absorption band in the Raman spectral ranges of 380 cm⁻¹ and 260 cm⁻¹.

Therefore, based on the above results, it may be confirmed that, in the electrolytes manufactured using aluminum fluoride (AlF₃), in which the mixing molar ratio of aluminum chloride (AlCl₃) to aluminum fluoride (AlF₃) is 9:1, two kinds of anions, i.e., AlCl₄ and AlCl₃F⁻, are present.

### Test Example 4: Confirmation of Film Layer Formed on Metal Surface after Charging and Discharging

Thereafter, in order to confirm changes in lithium metals present in anodes after charging and discharging of the batteries depending on whether or not the electrolytes are doped with fluorine (F), analysis was performed as below.

As an analysis method, after 200 cycles of electrochemical evaluation were performed, the cross-sections of lithium metals of lithium symmetric cells using the electrolytes according to Examples and Comparative Examples were observed.

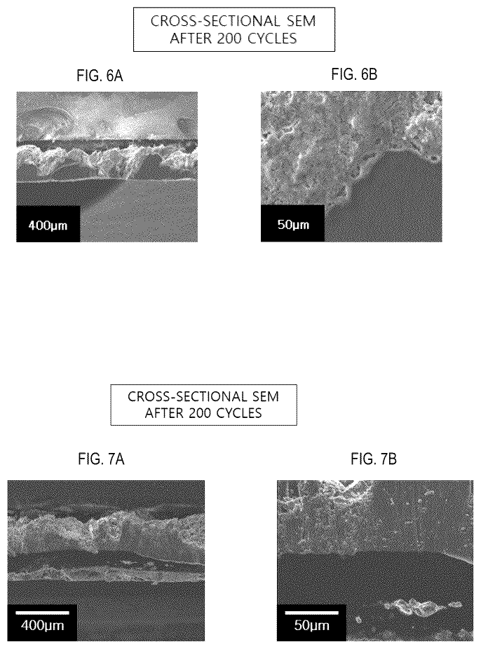

FIGS. 6A and 6B are scanning electron microscope (SEM) images of the cross-section of the lithium metal in the battery to which the electrolyte according to Comparative Example 1 is applied. Further, FIGS. 7A and 7B are SEM images of the cross-section of the lithium metal in the battery to which the electrolyte according to Comparative Example 2 is applied.

Concretely, FIG. 6B is an enlarged view of FIG. 6A, and FIG. 7B is an enlarged view of FIG. 7A.

Referring to FIGS. 6A and 6B and FIGS. 7A and 7B, it may be confirmed that non-uniform stripping occurred due to deposition and desorption of lithium and reaction byproducts of the electrolytes by the electrochemical evaluation. Further, it may be confirmed that the insides of the lithium metals were divided into a part in which non-cycled lithium metal is present and a part in which the non-cycled lithium metal is not present. It may be predicted that such a phenomenon was caused by high overvoltage generated during the electrochemical evaluation.

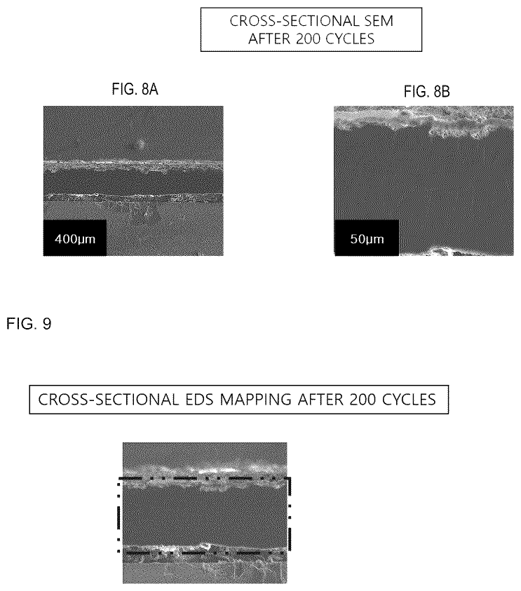

FIGS. 8A and 8B are SEM images of the cross-section of the lithium metal in the battery to which the electrolyte according to Example 1 is applied. Concretely, FIG. 8B is an enlarged view of FIG. 8A.

Referring to FIGS. 8A and 8B, non-cycled lithium metal having a thickness of about 200 μm was present. Further, it may be confirmed that the film layer formed on the surface of the lithium metal had a thickness of about 20 to 30 μm and a flat shape.

Therefore, it may be confirmed that the electrolyte according to embodiments of the present disclosure was doped with fluorine (F), and thus had low loss of lithium even after charging and discharging of the battery and exhibited excellent efficiency.

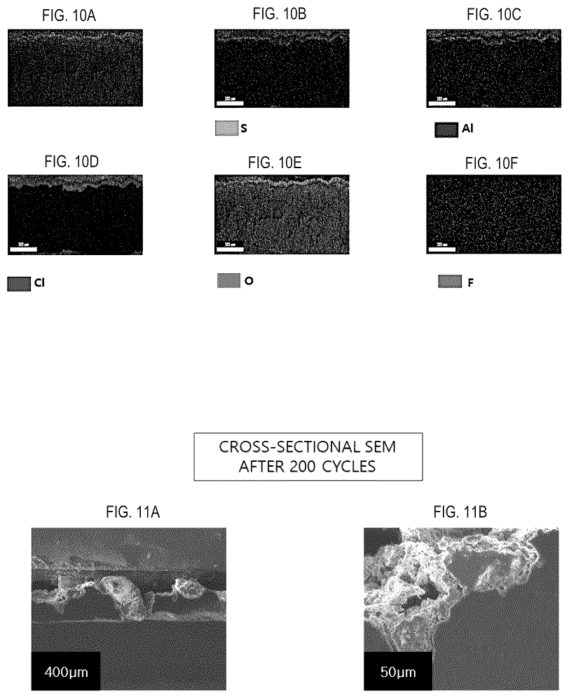

FIG. 9 is an image of an energy dispersive spectroscopy (EDS) mapping area of the cross-section of the lithium metal in the battery to which the electrolyte according to Example 1 is applied. Further, FIGS. 10A to 10F are images showing results of EDS mapping of the cross-section of the lithium metal in the battery to which the electrolyte according to Example 1 is applied.

Referring to FIG. 10F, it may be confirmed that the lithium metal was uniformly doped with fluorine (F).

FIGS. 11A and 11B are SEM images of the cross-section of the lithium metal in the battery to which the electrolyte according to Example 2 is applied. Concretely, FIG. 11B is an enlarged view of FIG. 11A.

Referring to FIGS. 11A and 11B, it may be confirmed that the film layer formed on the surface of the lithium metal had a thickness of about 100 to 150 μm, non-cycled lithium metal was not present, and damage to the lithium metal occurred.

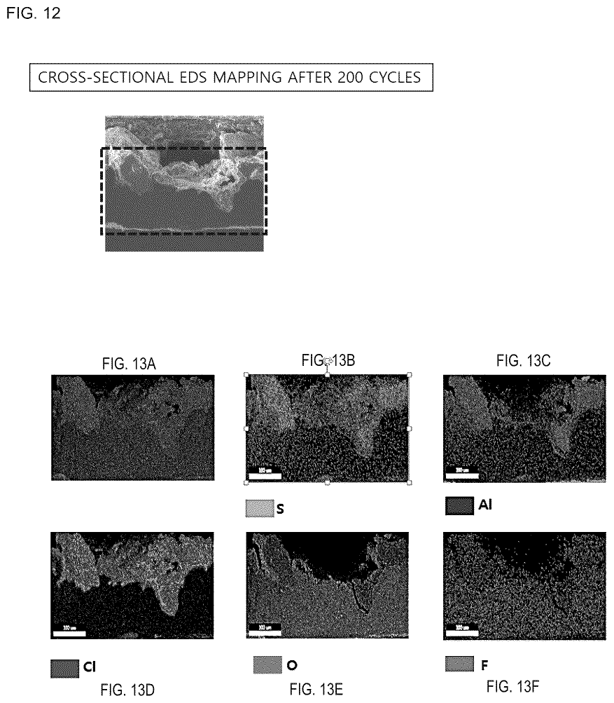

Further, FIG. 12 is an image of an EDS mapping area of the cross-section of the lithium metal in the battery to which the electrolyte according to Example 2 is applied, and FIGS. 13A to 13F are images showing results of EDS mapping of the cross-section of the lithium metal in the battery to which the electrolyte according to Example 2 is applied.

Referring to FIG. 13F, it may be confirmed that the lithium metal was uniformly doped with fluorine (F).

### Test Example 5: Component Analysis of Lithium Metals after Charging and Discharging of Batteries

Thereafter, in order to confirm changes in the lithium metals after charging and discharging of the batteries depending on whether or not the electrolytes are doped with fluorine (F), the components of the lithium electrodes in the lithium symmetric cells using the electrolytes according to Examples and Comparative Examples after the formation process of the batteries and after 100 cycles of the batteries were respectively analyzed through x-ray photoelectron spectroscopy (XPS).

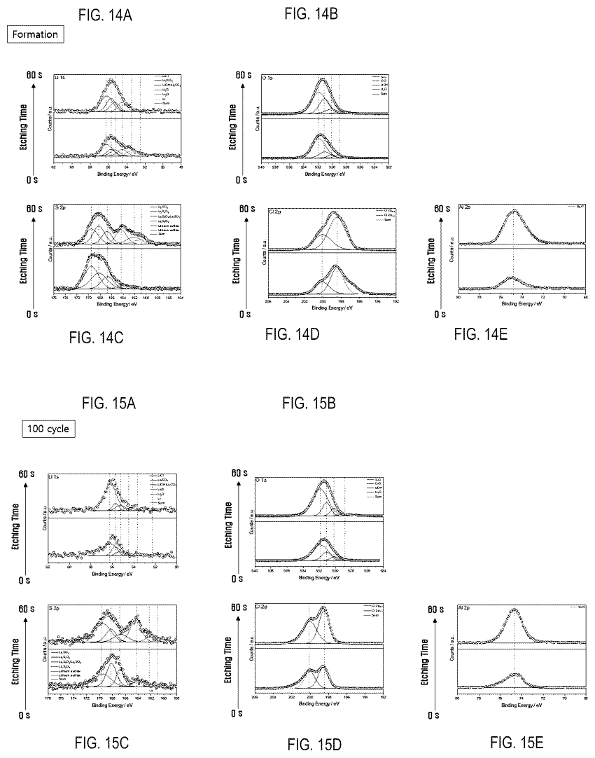

FIGS. 14A to 14E are graphs representing results of XPS of the lithium metal, after the formation process of the battery using the electrolyte according to Comparative Example 1. Further, FIGS. 15A to 15E are graphs representing results of X-ray Photoelectron Spectroscopy (XPS) of the lithium metal, after 100 cycles of the battery using the electrolyte according to Comparative Example 1.

Referring to FIGS. 14A to 14E, it is confirmed that the major components of the surface of the lithium electrode and the film layer formed thereon in the battery using the electrolyte according to Comparative Example 1 included LiCl and a lithium sulfur-oxy compound (LiₓS_{y}O_{z}).

Further, it is confirmed that the intensities of peaks of LiCl, LiₓS_{y}O_{z}, and lithium sulfide were increased after depth profiling in the battery using the electrolyte according to Comparative Example 1.

Referring to FIGS. 15A to 15E, it is confirmed that the major components of the surface of the lithium electrode and the film layer formed thereon in the battery using the electrolyte according to Comparative Example 1 after 100 cycles of the secondary battery were LiCl and the lithium sulfur-oxy compound (LiₓS_{y}O_{z}).

Further, it is confirmed that the intensities of the peaks of LiCl and LiₓS_{y}O_{z}, which are reaction byproducts, were increased after depth profiling in the battery using the electrolyte according to Comparative Example 1.

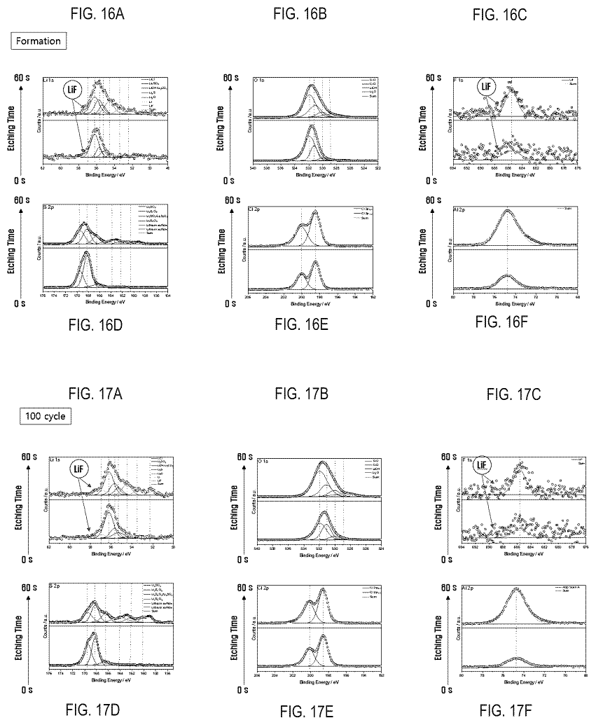

FIGS. 16A to 16F are graphs representing results of XPS of the lithium metal, after the formation process of the battery using the electrolyte according to Comparative Example 2. Further, FIGS. 17A to 17F are graphs representing results of XPS of the lithium metal, after 100 cycles of the battery using the electrolyte according to Comparative Example 2.

Referring to FIGS. 16A to 16F, it is confirmed that the surface of the lithium electrode and the film layer formed thereon in the battery using the electrolyte according to Comparative Example 2 included LiCl and the lithium sulfur-oxy compound (LiₓS_{y}O_{z}) as major components, and further included LiF.

Further, it is confirmed that the intensities of the peaks of the Li—S—O compound and LiF were increased after depth profiling in the battery using the electrolyte according to Comparative Example 2.

Referring to FIGS. 17A to 17F, it is confirmed that the surface of the lithium electrode and the film layer formed thereon in the battery using the electrolyte according to Comparative Example 2 after 100 cycles of the secondary battery included LiCl and the Li—S—O compound as major components, and further included LiF.

Further, it is confirmed that the intensities of the peaks of the Li—S—O compound, LiF, and lithium sulfide were increased after depth profiling in the battery using the electrolyte according to Comparative Example 2.

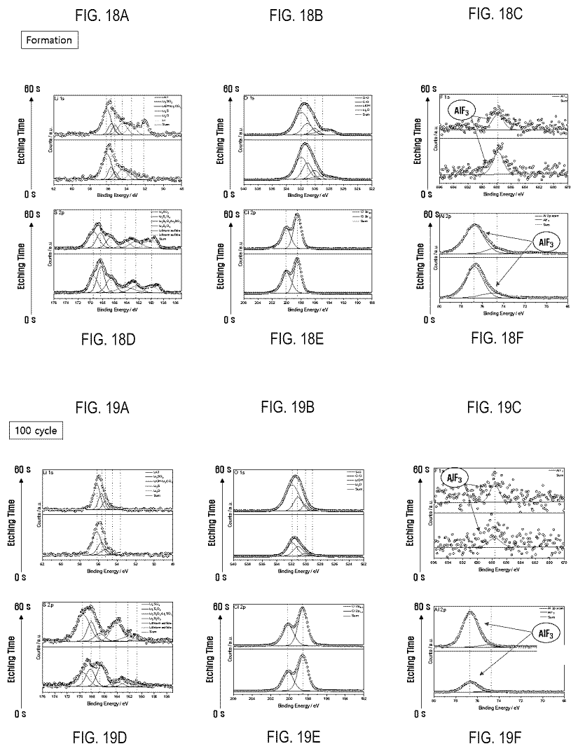

FIGS. 18A to 18F are graphs representing results of XPS of the lithium metal, after the formation process of the battery using the electrolyte according to Example 1. Further, FIGS. 19A to 19F are graphs representing results of XPS of the lithium metal, after 100 cycles of the battery using the electrolyte according to Example 1.

Referring to FIGS. 18A to 18F, it is confirmed that the major components of the surface of the lithium electrode and the film layer formed thereon in the battery using the electrolyte according to Example 1 were LiCl and the Li—S—O compound, and the film layer further included AlF₃.

Further, it is confirmed that the intensities of the peaks of the Li—S—O compound and AlF₃ were significantly increased after depth profiling in the battery using the electrolyte according to Example 1.

Therefore, it may be predicted that the thickness of a surface layer including the formed film layer in the battery using the electrolyte according to Example 1 is less than those of surface layers in the batteries using other SO₂-based electrolytes.

Referring to FIGS. 19A to 19F, it is confirmed that the major components of the surface of the lithium electrode and the film layer formed thereon in the battery using the electrolyte according to Comparative Example 2 after 100 cycles of the secondary battery were LiCl and the Li—S—O compound, and the film layer further included AlF₃.

Further, it is confirmed that the intensities of the peaks of the Li—S—O compound and AlF₃ were increased after depth profiling in the battery using the electrolyte according to Example 1.

Therefore, when an etching time is increased in the battery using the electrolyte according to Example 1, a peak relating to LiF generated due to reaction between Li and AlF₃ may appear.

### Test Example 6: Application of Substituted Inorganic Liquid Electrolyte to Cathode

Thereafter, after the inorganic electrolytes manufactured according to Examples and Comparative Examples were applied to batteries including cathodes including lithium iron phosphate (LFP) and cathodes including lithium metal, electrochemical evaluation of the batteries was performed. Here, in the electrochemical evaluation, a loading level was 11 mg/cm².

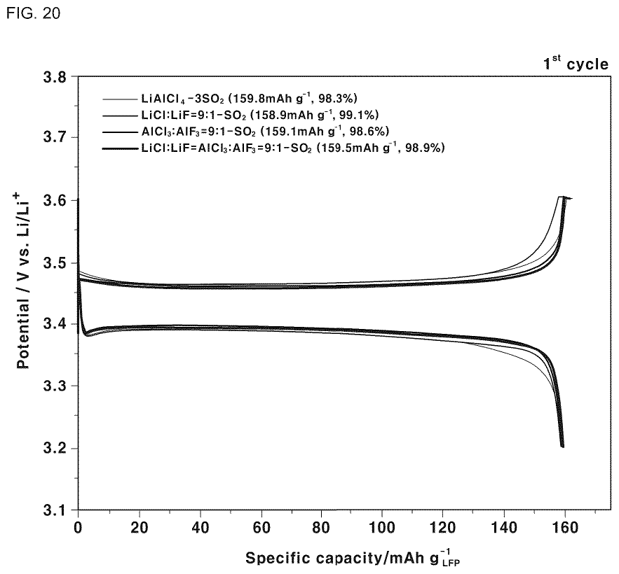

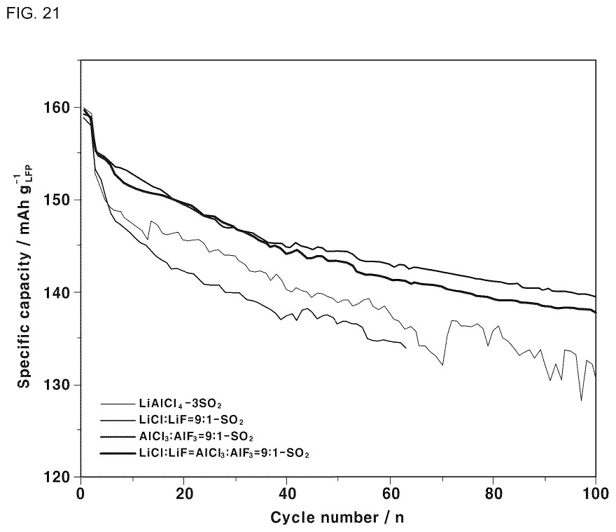

FIG. 20 is a graph representing results of measurement of capacities, after application of the inorganic electrolytes according to Examples and Comparative Examples to LFP cathodes and lithium metal cathodes.

Further, FIG. 21 is a graph representing results of a charge and discharge cycle test, after application of the inorganic electrolytes according to Examples and Comparative Examples to the LFP cathodes and the lithium metal cathodes.

Referring to FIGS. 20 and 21, it may be confirmed that the sulfur dioxide-based inorganic electrolytes including aluminum fluoride (AlF₃) exhibited the most improved lifespan.

As is apparent from the above description, a sulfur dioxide-based inorganic electrolyte doped with a fluorine compound according to embodiments of the present disclosure has high ionic conductivity while having non-flammable properties, and may thus be applied to a secondary battery so as to exhibit high electrochemical stability.

Further, the sulfur dioxide-based inorganic electrolyte according to embodiments of the present disclosure suppresses formation dendrites on the surface of lithium metal due to a film layer including aluminum fluoride (AlF₃) formed on the surface of the lithium metal, and may thus be used to manufacture a lithium secondary battery having improved capacity.

Embodiments of the disclosure have been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A sulfur dioxide-based inorganic electrolyte represented by a chemical formula
M·(A1·Cl_{(4-X)}Fₓ)_{z}·ySO₂,
wherein M is a first element selected from the group consisting of Li, Na, K, Ca, and Mg,
wherein A1 is a second element selected from the group consisting of Al, Fe, Ga, and Cu,
wherein x satisfies a first equation 0≤x≤4,
wherein y satisfies a second equation 0≤y≤6, and
wherein z satisfies a third equation 1≤z≤2.

2. The sulfur dioxide-based inorganic electrolyte of claim 1, wherein a molar content of fluorine in the sulfur dioxide-based inorganic electrolyte is 0.03 to 0.9.

3. The sulfur dioxide-based inorganic electrolyte of claim 1, wherein a molar content of fluorine in the sulfur dioxide-based inorganic electrolyte is 0.04 to 1.2.

4. A secondary battery comprising:
a cathode;
an anode comprising lithium metal;
a film layer on a surface of the lithium metal and comprising a fluorine compound; and
a separator located between the cathode and the anode;
wherein the secondary battery is impregnated with a sulfur dioxide-based inorganic electrolyte represented by a chemical formula M·(A1·Cl₍₄₋ₓ₎Fₓ)_{z}·ySO₂, wherein M is a first element selected from the group consisting of Li, Na, K, Ca, and Mg, A1 is a second element selected from the group consisting of Al, Fe, Ga, and Cu, x satisfies a first equation 0≤x≤4, y satisfies a second equation 0≤y≤6, and z satisfies a third equation 1≤z≤2.

5. The secondary battery of claim 4, wherein the fluorine compound comprises aluminum fluoride (AlF₃).

6. The secondary battery of claim 4, wherein the film layer has a thickness of 3 to 150 μm.

7. The secondary battery of claim 4, wherein a molar content of fluorine in the sulfur dioxide-based inorganic electrolyte is 0.03 to 0.9.

8. The secondary battery of claim 4, wherein a molar content of fluorine in the sulfur dioxide-based inorganic electrolyte is 0.04 to 1.2.

9. A method of manufacturing a sulfur dioxide-based inorganic electrolyte, the method comprising:
preparing a mixture by mixing metal chlorides and a fluorine compound; and
synthesizing the sulfur dioxide-based inorganic electrolyte doped with fluorine compound by injecting sulfur dioxide (SO₂) gas into the mixture; and
wherein the sulfur dioxide-based inorganic electrolyte is represented by a chemical formula M·(A1·Cl₍₄₋ₓ₎Fₓ)_{z}·ySO₂, wherein M is a first element selected from the group consisting of Li, Na, K, Ca, and Mg, A1 is a second element selected from the group consisting of Al, Fe, Ga, and Cu, x satisfies a first equation 0≤x≤4, y satisfies a second equation 0≤y≤6, and z satisfies a third equation 1≤z≤2.

10. The method of claim 9, wherein:
the metal chlorides comprise:
a first metal chloride comprising a first compound selected from the group consisting of aluminum chloride (AlCl₃), iron chloride (FeCl₃), and gallium chloride (GaCl₃); and
a second metal chloride comprising a second compound selected from the group consisting of lithium chloride (LiCl), sodium chloride (NaCl), potassium chloride (KCl), calcium chloride (CaCl₂), and magnesium chloride (MgCl₂); and
the fluorine compound comprises a first fluorine compound selected from the group consisting of aluminum fluoride (AlF₃), iron fluoride (FeF₃), gallium fluoride (GaF₃), and combinations thereof.

11. The method of claim 10, wherein a molar content of fluorine in the sulfur dioxide-based inorganic electrolyte is 0.03 to 0.9.

12. The method of claim 10, wherein, in preparing the mixture, a content of the first fluorine compound is equal to or less than 11 mol % to a content of the first metal chloride.

13. The method of claim 10, wherein a mixing molar ratio of the first fluorine compound to the first metal chloride is 1:3 to 1:100.

14. The method of claim 10, wherein a mixing molar ratio of the first fluorine compound to the first metal chloride is 1:8 to 1:10.

15. The method of claim 9, wherein the fluorine compound comprises two or more fluorine compounds.

16. The method of claim 9, wherein:
the metal chlorides comprise:
a first metal chloride comprising a first compound selected from the group consisting of aluminum chloride (AlCl₃), iron chloride (FeCl₃), and gallium chloride (GaCl₃); and
a second metal chloride comprising a second compound selected from the group consisting of lithium chloride (LiCl), sodium chloride (NaCl), potassium chloride (KCl), calcium chloride (CaCl₂), and magnesium chloride (MgCl₂); and
the fluorine compound comprises:
a first fluorine compound comprising a third compound selected from the group consisting of aluminum fluoride (AlF₃), iron fluoride (FeF₃), and gallium fluoride (GaF₃); and
a second fluorine compound comprising a fourth compound selected from the group consisting of lithium fluoride (LiF), sodium fluoride (NaF), potassium fluoride (KF), calcium fluoride (CaF₂), and magnesium fluoride (MgF₂).

17. The method of claim 16, wherein a molar content of fluorine in the sulfur dioxide-based inorganic electrolyte is 0.04 to 1.2.

18. The method of claim 16, wherein, in preparing the mixture:
a content of the first fluorine compound is equal to or less than 11 mol % to a content of the first metal chloride; and
a content of the second fluorine compound is equal to or less than 11 mol % to a content of the second metal chloride.

19. The method of claim 16, wherein:
a mixing molar ratio of the first fluorine compound to the first metal chloride is 1:3 to 1:100; and
a mixing molar ratio of the second fluorine compound to the second metal chloride is 1:3 to 1:100.

20. The method of claim 16, wherein:
a mixing molar ratio of the first fluorine compound to the first metal chloride is 1:8 to 1:10; and
a mixing molar ratio of the second fluorine compound to the second metal chloride is 1:8 to 1:10.
